(19) United States
(12) Patent Application Publication
(10) Pub. No.: US 2003/0233790 A1
(43) Pub. Date: Dec. 25, 2003

(54) Device for detecting an obstacle in the opening range of a powered closure element for a motor vehicle

(75) Inventor: Roland Nuber, Lindau (DE)

Correspondence Address: Stephen B. Salai, Esq., Harter, Secrest & Emery LLP, 1600 Bausch & Lomb Place, Rochester, NY, 14604-2711, US

(73) Assignee: Metzeler Automotive Profile Systems GmbH, Lindau (DE)

(21) Appl. No.: 10/429,582

(22) Filed: May 5, 2003

(30) Foreign Application Priority Data
May 6, 2002 (DE) 102 20 187.0

(51) Int. Cl. E05F 15/02

(52) U.S. Cl. 49/28

(57) ABSTRACT

A device for detecting an obstacle in the opening range of a closure element of a motor vehicle (10) movable between an open position and a closed position, more particularly an electrically powered window pane (20) or sunroof, comprises a sealing profile (30) sealing the closure element (20). The sealing profile (30) is made of an elastomeric material and secured to a frame (12) of the motor vehicle (10). In addition, the device comprises a sensor for detecting an obstacle in the opening range of the closure element (20) which includes at least one electrical conductor (40) generating an electrical field in the opening range of the closure element (20). Such a device is characterized by being comparatively cheap in production whilst featuring relatively simple assembly and maintenance. The reason for this is that the conductor (40) is arranged on a trim (50) providing finishing concealment of the frame (12) or the sealing profile (30) at least in part, wherein the trim (50) is stationary secured to the motor vehicle (10).

### CROSS-REFERENCE TO RELATED APPLICATIONS

This application claims priority to German Patent Application Number 102 20 187.0 filed May 6, 2002.

### STATEMENT REGARDING FEDERALLY SPONSORED RESEARCH OR DEVELOPMENT

Not applicable

### REFERENCE TO A “SEQUENCE LISTING”

Not applicable.

### BACKGROUND OF THE INVENTION

1. Field of the Invention

The invention relates to a device for detecting an obstacle in the opening range of an automotive closure element movable between an open position and a closed position, more particularly an electrically powered window pane or sunroof. The device is provided with an elastomeric sealing profile sealing the closure element and secured to a frame of the motor vehicle. In addition, the device is provided with a sensor for detecting an obstacle in the opening range of the closure element comprising at least one electrical conductor generating an electrical field in the opening range of the closure element.

2. Background Art

Devices of this kind are guards serving to prevent part of the human body being trapped between the closure element and at least some part of the edge surrounding the closure element. For this purpose known devices feature a sensor which detects the presence of an obstacle in the opening range of the closure element and furnishes a signal controlling the motor powering the closure element. As regards the function of the sensor a distinction is made between guards requiring physical contact with the obstacle and guards working by proximity (non-contact) detecting.

One such guard belonging to the first group is described, for example, in DE 199 13 105 A1. This known device comprises a sealing profile sealing a closure element and is engineered with two electrically conductive portions spaced away from each other. When physical contact occurs with an obstacle in the opening range of the closure element the electrically conductive portions are pressed together, resulting in a switching contact which triggers an electrical control signal.

Known from EP 1 154 110 A2 is a proximity or non-contact type guard. The way in which this guard works is based on a change in capacitance of an electrical field generated between two electrical conductors prompted by an obstacle in the opening range of a closure element. One of the conductors, the sensor electrode, is integrated in a sealing profile sealing the closure element, whereas the other conductor, the basic electrode is formed, for example, by an automotive frame to which the sealing profile is secured. To also detect non-conductive materials, such as, for example, wood or plastics, prompting no, or only a minor, change in the capacitance of the electric field, the portion of the sealing profile accommodating the sensor electrode is deformable. This makes sure that at least when an obstacle comes into physical contact with the sealing profile there is a change in the position of the sensor electrode which triggers a change in the capacitance.

All of these known devices have the disadvantage that an electrical conductor necessary for detecting the obstacle is connected to a sealing profile sealing the closure element. In this arrangement the conductor is configured for example, as a conductive portion of the sealing profile or a wire integrated in the sealing profile by coextrusion. This results in the production costs of sealing profile being relatively high. In addition to this, experience has shown that integrating the electrical conductor in the sealing profile is a drawback in assembly, it being especially in curved portions such as, for example, in the transition from the A pillar to the roof of a motor vehicle that the sealing profile is squeezed to such an extent that there is a risk of the electrical conductor being damaged.

Apart from this, integrating the electrical conductor in the sealing profile involves relatively complicated logistics as regards the remaining components of the sensor which as a rule are fabricated together with the sealing profile. Last but not least, integrating the electrical conductor in the sealing profile hampers trouble-shooting a defective guard.

### BRIEF SUMMARY OF THE INVENTION

The invention is based on the objective of sophisticating a device of the aforementioned kind such that as compared to prior art lower production costs as well as simplified assembly and maintenance are now achieved.

To achieve this objective it is provided for in a device having the aforementioned features as it reads from claim 1 that the conductor is arranged on trim covering the frame and/or sealing profile at least in part and stationary secured to the motor vehicle.

The device in accordance with the invention is based on having discovered the advantages of configuring the sealing profile and the electrical conductor necessary for detecting an obstacle in the opening range of the closure element as separately components, this now making it possible to reduce the production costs of the sealing profile whilst facilitating assembly and maintenance. The reason for this is primarily due to decoupling the functions of the sealing profile and electrical conductor. Now, unlike prior art, the conductor is mounted on trim covering the frame and/or sealing profile at least in part. In this arrangement the device in accordance with the invention makes use of the fact that such trim, for example, in the form of a molding is employed in any case for visual appeal on the majority of conventional closure elements such as, for instance, a window pane. Accordingly, no additional work is involved in production and assembly.

Furthermore, the device in accordance with the invention reduces the logistical complications since, now, all components relating to the sensor can be made and furnished separately as outsourced items. In conclusion, the configuration in accordance with the invention ensures fitting the electrical conductor as is favorable for detecting an obstacle in the opening range of a closure element without influencing the arrangement of the sealing profile. This now makes it possible to take into account the special requirements of certain closure elements such as, for instance, doors, hatchback, trunk lid of a motor vehicle characterized by a relatively large spacing between sealing profile and a potential trapping zone.

Thus, in effectively configuring an electrical field by the electrical conductor it is of advantage to make the trim for electrically insulating the conductor of a dielectric material, preferably plastics material. A dielectric material in this sense is understood to be an insulant which ensures propagation of the electrical field without any significant increase in the capacitance.

It is in addition particularly of advantage to embed the conductor as an alternative or in addition thereto in a sheathing made of an elastomeric dielectric material secured to the trim. The sheathing protecting the electrical conductor from the environment may consist of an insulating rubber, for example, sponge rubber so that the conductor can be embedded in the sheathing by coextrusion cost effectively. In addition to this, such an aspect permits making the trim from metal, for example, aluminum.

Advantageously, the conductor is configured stranded or as a band to facilitate production. To make for simply assembly it is in addition of advantage to secure the conductor by a materially positive connection or positive or non-positive locking. Supplementing for instance a positive or non-positive connection by a material positive connection, for example, by bonding is particularly favorable for reliably and durably securing the conductor.

Connecting the conductor to the trim by positive locking and, where necessary, also by non-positive locking is achievable in one advantageous aspect of the device in accordance with the invention by locating the conductor between at least two webs configured on the trim. To facilitate speedy assembly the conductor may be clamped in place as an alternative also by a protuberance formed on the trim.

In another preferred aspect of the device in accordance with the invention the conductor may be located in a gap configured in the trim. In this case, it has proven to be expedient when the trim is flexible at least in the region of the gap in opening up the gap for simple insertion of the conductor. In addition this enables the gap to be configured in the form of a relief so that the conductor inserted in the gap is held in place both by positive locking and where necessary also by non-positive locking.

Preferably the trim is connected to the sealing profile by positive locking to achieve reliable fastening of the trim to the motor vehicle.

In conclusion, it is proposed in another preferred embodiment of the device in accordance with the invention to configure the trim as a molding extending along the sealing profile to make for added visual appeal.

### BRIEF DESCRIPTION OF THE SEVERAL VIEWS OF THE DRAWING(S)

The device in accordance with the invention and its further advantages will now be detained by way of describing preferred example embodiments with respect to the drawings illustrated therein merely diagrammatically in which:

FIG. 1 is a side view of a motor vehicle;

FIG. 2 is a sectional view taken along the line II in FIG. 1 showing a first embodiment of the present invention;

FIG. 3a is a view as shown in FIG. 2 but in a second embodiment of the present invention;

FIG. 3b is a view as shown in FIG. 3a but in a third embodiment of the present invention;

FIG. 3c is a view as shown in FIG. 3a but in a fourth embodiment of the present invention;

FIG. 3d is a view as shown in FIG. 3a but in a fifth embodiment of the present invention;

FIG. 4a is a sectional view taken along the line II in FIG. 1 showing a sixth embodiment of the present invention;

FIG. 4b is a view as shown in FIG. 4a showing an expanded sealing profile;

FIG. 5a is a cross-section through a trim in the opened up condition;

FIG. 5b is a cross-section through the trim as shown in FIG. 5a but in the closed condition;

FIG. 5c is a view as shown in FIG. 5b showing how the trim is secured to a frame; and

FIG. 6 is a sectional view taken along the line II in FIG. 1 showing a seventh embodiment of the present invention.

### DETAILED DESCRIPTION OF THE INVENTION

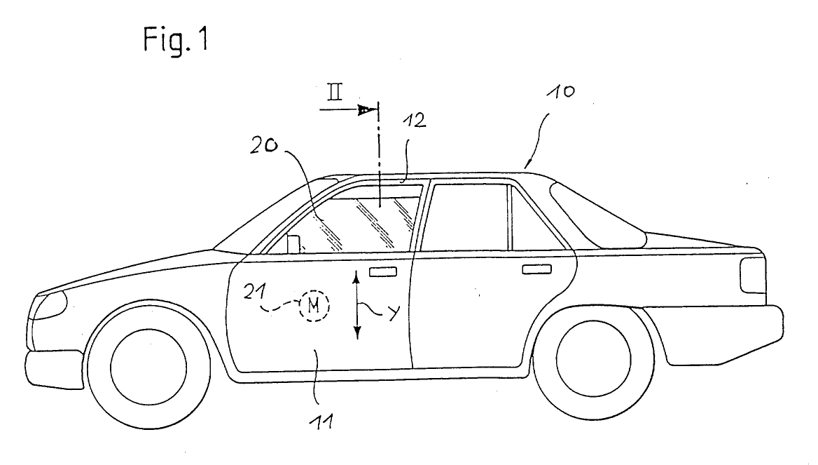

Referring now to FIG. 1 there is illustrated a motor vehicle 10 provided in the region of a front door 11 with a window pane 20 powered by an electric motor 21. The window pane 20 representing a closure element is powered in the direction y of the electric motor 21 between an open position and its closed position.

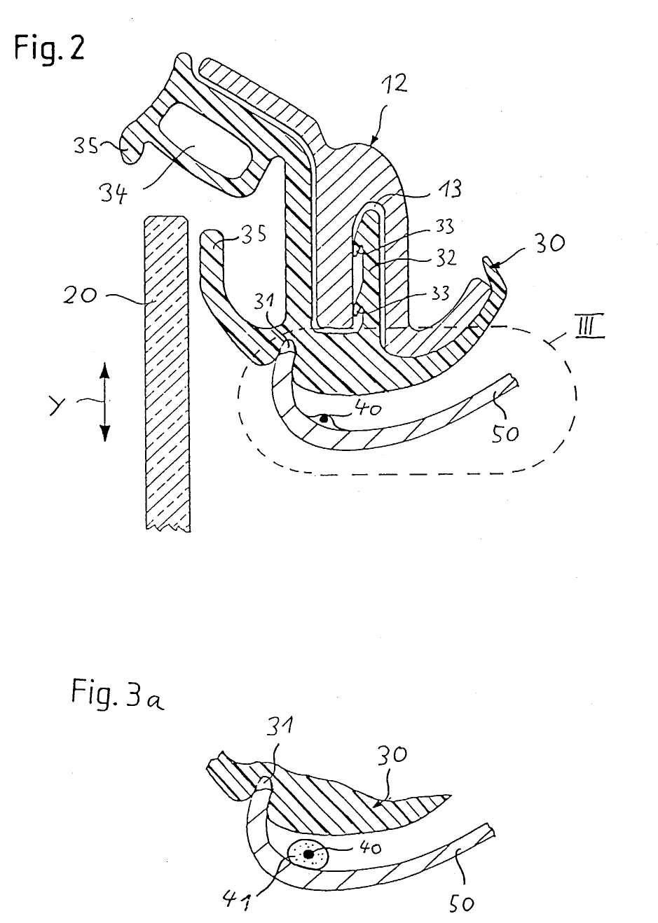

As evident from FIG. 2 the front door 11 comprises a metal frame 12 to which a sealing profile 30 seals the window pane 20. The sealing profile 30 made of an electrically non-conducting elastomeric material comprises a fastening portion 32 extending along a channel 13 in the frame 12 and provided with retaining lips 33 for locating the sealing profile 30. In addition, the sealing profile 30 is provided with a cavity 34 and sealing lips 35 for guiding and sealing the window pane 20. Furthermore the sealing profile 30 comprises a recess 31 for positive connection of a molding 50. The molding 50 serves to finish the sealing profile 30 and frame 12 at least in part in adding to the visual appeal. The molding 50 made of plastics material and arranged stationary is provided with an electrical conductor 40. The electrical conductor 40 represents a sensor electrode as described in EP 1 154 110 A2 and serves to generate an electrical field. In this arrangement the grounded frame 12 forms the opposing electrode needed to maintain the electrical field. An analyzer (not shown) detects the change in the capacitance caused by an obstacle in the opening range of the 20 and furnishes as a function of the change a signal for controlling the electric motor 21 which halts the electric motor 21, when necessary. Depending on the particularly application the molding 50 may be configured pliable so that on physical contact with an obstacle the molding 50 is deformed, prompting a change in the capacitance of the electrical field for evaluation as a control signal. To ensure adequate deformability the molding 50 is spaced away from 30 at least in the region of the electrical conductor 40 so that the molding 50 forms a so-called softspot in the region of the electrical conductor 40.

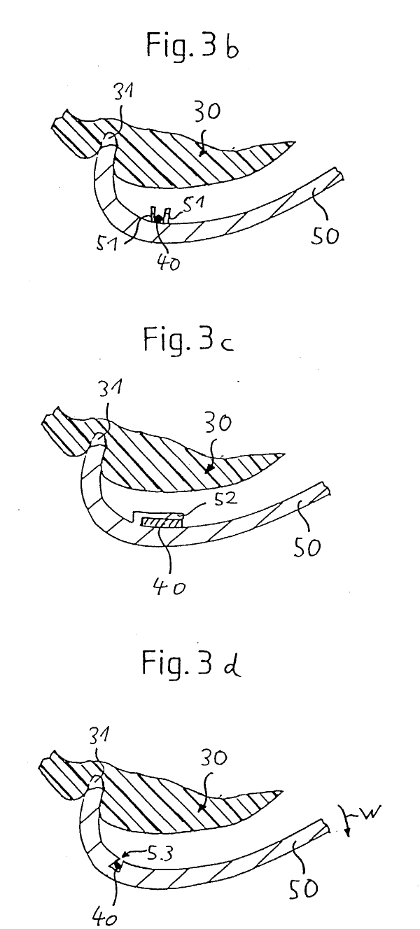

Referring now to FIGS. 3a to 3d there are illustrated alternative embodiments of how the electrical conductor 40 is configured and arranged. Common to all embodiments is that the electrical conductor 40 is arranged at the side of the molding 50 facing the sealing profile 30 in thus being concealed from view without so that the electrical conductor 40 does not spoil the visual appeal of the finish afforded by the molding 50.

Referring now to FIG. 3a there is illustrated an embodiment of the electrical conductor configured stranded, surrounded by a protective sheathing 41. The sheathing 41 is made of a non-conducting elastomeric material, for example, sponge rubber fabricated by coextrusion. The sheathing 41 is bonded to the molding 50 for a materially positive connection.

Referring now to FIG. 3b there is illustrated an embodiment of the electrical conductor 40 configured likewise as a thin wire or stranded. Unlike the embodiment as shown in FIG. 2 the electrical conductor 40 is not integrated in the molding 50, for example, by injection molded, it instead being located between two webs 51 configured on the molding 50. In this arrangement, these webs 51 may form a continuous channel or a line of fingers. Providing the webs 51 permits outsourcing production of the molding 50 and electrical conductor 40 separately whilst ensuring facilitated, speedy assembly.

Referring now to FIG. 3c there is illustrated an embodiment of the electrical conductor 40 configured as a strip clamped in place by a protuberance 52 formed on the molding 50. In this case too, electrical conductor 40 and molding 50 can be outsourced in separate production for facilitated, speedy connecting together.

Referring now to FIG. 3d there is illustrated an embodiment of the molding 50 featuring a gap 53 in which the electrical conductor 40 is located. The gap 53 is configured in the form of a relief positively preventing the electrical conductor 40 from breaking out of place. To insert the electrical conductor 40 into the gap 53 it is necessary to bend the molding 50 in the direction indicated in FIG. 3d by “w”, as a result of which the gap 53 is opened up. Depending on the dimensioning of the gap 53 this also makes it possible to clamp in place the electrical conductor 40 in the gap 53 by non-positive locking.

The embodiments as described above for a device for detecting an obstacle in the opening range of the window pane 20 excel over conventional guards by being relatively cheap in production whilst featuring relatively simple assembly and maintenance. The main reason for this is that the electrical conductor 40 is arranged on the molding 50 providing finishing concealment of the frame 12 and sealing profile 30 at least in part. It is in this way that for both production as well as for assembly and maintenance that the electrical conductor 40 permitting detecting an obstacle in the opening range of the window pane 20 is now decoupled from the sealing profile 30. This decoupling effect not only simplifies production, it also enables the electrical conductor 40 to be arranged at a location best suited for detecting an obstacle. For, unlike the sealing profile 30 which as a rule has the task of providing a reliable seal whilst guiding the powered window pane 20, arranging the molding 50, mainly subject to the requirements of visual appeal, can now be varied to a greater degree.

Apart from this, arranging the electrical conductor 40 on the molding 50 has the advantage that the sealing profile 30 can now be configured independently of the electrical conductor 40 as regards shape and material. On top of this, due to the stationary arrangement of the molding 50 the electrical conductor 40 is now subject to no, or at the most low, dynamic stress in thus ensuring it being clamped in place with low wear and thus durably. Last but not least, the pliancy of the molding 50 can be adapted to the particular application by suitably selecting material and dimensioning to thus take into account the softspot requirements as mentioned above.

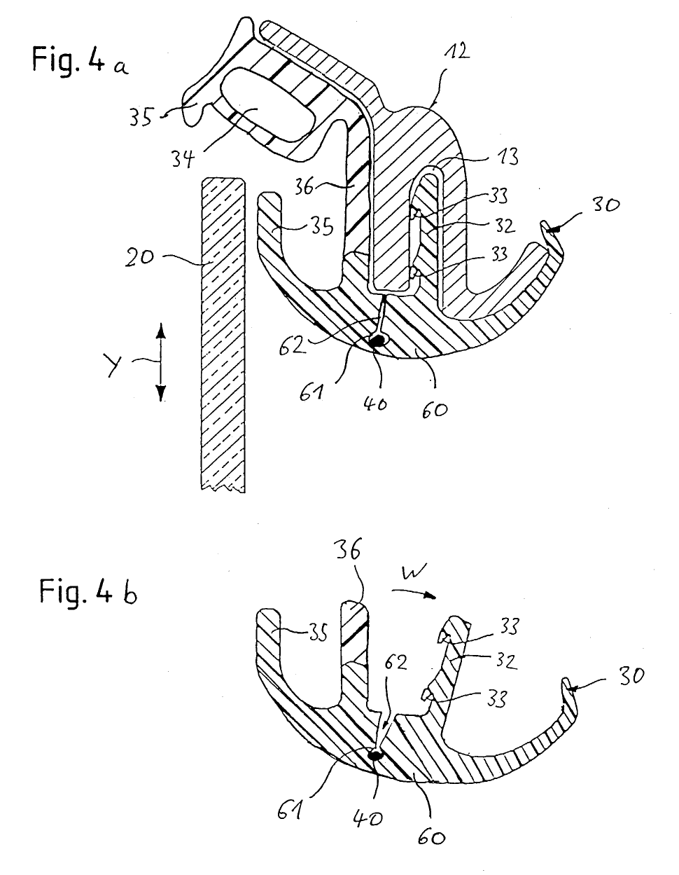

Referring now to FIGS. 4a and 4b there is illustrated a further embodiment of how the electrical conductor 40 is arranged in a recess 61 of a trim 60 made of an elastomeric material. The trim 60 may be, for example, fabricated in coextrusion with the sealing profile 30 and unlike an electrically conducting portion 36 of the sealing profile 30 made of a non-conducting rubber. The recess 61 joins a gap 62 extending through the sealing profile 30 and porting the side of the sealing profile 30 facing the frame 12. As evident from FIG. 4b the electrical conductor 40 can be easily inserted into the recess 61 by bending the 30 in the direction as indicated by “w” when non-assembled, as a result of which the gap 62 is opened up, whereas when the sealing profile 30 is assembled the gap 62 is closed to thus positively retain the electrical conductor 40 in the recess 61, as evident from FIG. 4a.

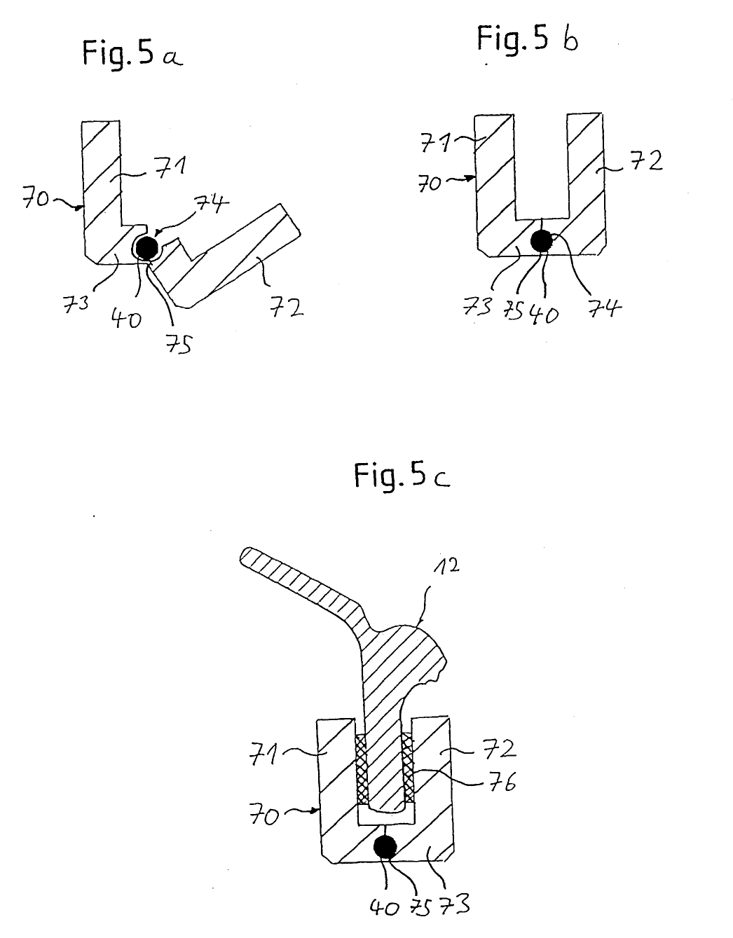

Referring now to FIGS. 5a to 5c there is illustrated a similar aspect for securing the electrical conductor 40. A trim 70 of U-shaped cross-section has legs 71, 72 and a base 73. Provided in the base 73 of the trim 70 made for example, of a plastics material is a recess 74 in which the electrical conductor 40 is arranged. Interposed between the outer surface of the base 73 and the recess 74 is a relatively thin web 75 acting like a live hinge to permit hinging the leg 72 relative to leg 71. As evident from FIG. 5a the electrical conductor 40 can be inserted with no problem into the recess 74 with the leg 72 hinged open, whereas in the closed condition the electrical conductor 40 is positively held in the recess 74 as shown in FIG. 5b. Hinging open the legs 71, 72 is prevented in the assembled condition of the trim 70 by adhesive 76 which joins the inner surfaces of the legs 71, 72 to the opposite surfaces of the frame 12 as evident from FIG. 5c.

Both the aspect as shown in FIGS. 4a and 4b as well as the aspect as shown in FIGS. 5a to 5c are characterized by facilitated, reliable location of the electrical conductor 40 in the trim 60, 70. In both cases the electrical conductor is inserted into the recess 61, 74 from the frame side with the advantage that, for one thing, once fitted, the trim 60, 70 of the electrical conductor 40 is non-releasably located in the recess 61, 74, and, for another, the visual appeal of the exposed outer surface of the trim 60, 70 is not detrimented.

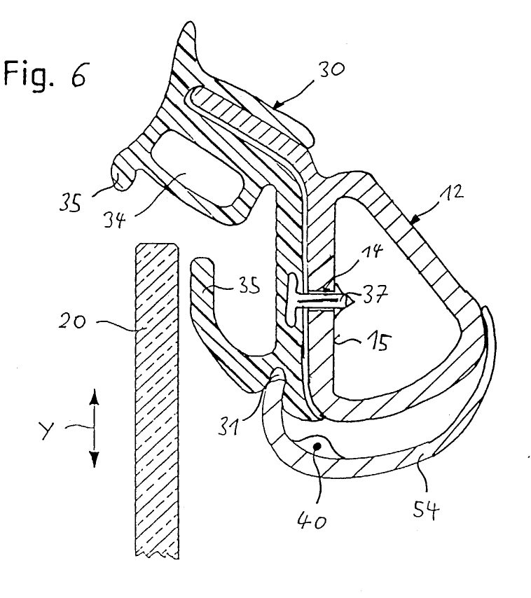

Referring now to FIG. 6 there is illustrated a further embodiment which unlike that as shown in FIG. 2 shows how the sealing profile 30 in this case is secured to the frame 12 by means of a clip fastener 37. The clip fastener 37 connected to the sealing profile 30 penetrates for this purpose a hole 14 drilled in the frame 12 to clasp a surface area 15 of the frame 12 facing away from the sealing profile 30. The electrical conductor 40 is arranged on a trim 54 finishing the frame 12. In this arrangement, the electrical conductor 40 can be joined to the trim 54 the same as shown in FIGS. 2 and 3a to 3d.

The device for detecting an obstacle as described above may find application not only as a guard for the window pane 20 but also for other closure elements of the motor vehicle 10 such as a sun-roof, a hatchback or a trunk lid. The important thing is that a molding 50 or some other kind of trim for securing the electrical conductor 40 can be provided.

1. A device for detecting an obstacle in the opening range of a closure element of a motor vehicle movable between an open position and a closed position, more particularly an electrically powered window pane or sunroof, comprising a sealing profile sealing said closure element, said sealing profile being made of an elastomeric material and secured to a frame of said motor vehicle, and a sensor for detecting an obstacle in the opening range of said closure element, said sensor including at least one electrical conductor generating an electrical field in the opening range of said closure element, said conductor being arranged on a trim covering said frame or said sealing profile at least in part and stationary secured to said motor vehicle.

2. The device as set forth in claim 1, wherein said trim for electrically insulating said conductor is made of a dielectric material, preferably plastics material.

3. The device as set forth in claim 1, wherein said conductor is embedded in a sheathing made of an elastomeric dielectric material, said sheathing being secured to said trim.

4. The device as set forth claim 1, wherein said conductor is configured as a strand or strip.

5. The device as set forth in claim 1, wherein said conductor is connected to said trim by positive or non-positive locking.

6. The device as set forth in claim 5, wherein said conductor is located between at least two webs formed on said trim.

7. The device as set forth in claim 5, wherein said conductor can be clamped in place by a protuberance formed on said trim.

8. The device as forth in claim 5, wherein said conductor is located in a gap configured in said trim.

9. The device as set forth in claim 8, wherein said trim is elastically deformable at least in the region of said gap.

10. The device as set forth in claim 1, wherein said conductor is connected to said trim by a materially positive connection.

11. The device as set forth in claim 1, wherein said trim is connected to said scaling profile by positive locking.

12. The device as set forth in claim 11, wherein said trim is configured as a molding extending along said sealing profile.
